(19) United States
(12) Patent Application Publication
(10) Pub. No.: US 2021/0049250 A1
(43) Pub. Date: Feb. 18, 2021

(54) AUTHENTICATION DEVICE

(71) Applicant: HONDA MOTOR CO., LTD., Tokyo (JP)

(72) Inventor: Yoshihiro Matsugi, Wako-shi (JP)

(21) Appl. No.: 16/984,197

(22) Filed: Aug. 4, 2020

(30) Foreign Application Priority Data
Aug. 13, 2019 (JP) 2019-148387

(51) Int. Cl. G06F 21/32; G06F 3/042; G06F 3/01; G06K 9/00

(52) U.S. Cl. CPC G06F 21/32; G06K 9/00912; G06F 3/013; G06F 3/0425

(57) ABSTRACT

An authentication device includes a display unit configured to have a display surface and have a function of detecting that a user has contacted the display surface, an imaging unit that is provided around the display surface of the display unit, a display control unit configured to control the display unit such that the display unit displays a reception image that receives an instruction to start user authentication, and an authentication device configured to execute the user authentication using an image captured by the imaging unit at a time at which a predetermined time has elapsed since a time at which it is detected by the display unit that an operation of contacting the reception image has been performed.

### CROSS-REFERENCE TO RELATED APPLICATION

Priority is claimed on Japanese Patent Application No. 2019-148387, filed Aug. 13, 2019, the content of which is incorporated herein by reference.

### BACKGROUND OF THE INVENTION

### Field of the Invention

The present invention relates to an authentication device.

### Description of Related Art

In recent years, a technology which executes user authentication using an image obtained by capturing a face or the like of a user sitting on a driver's seat of a vehicle and automatically adjusts a position of the driver's seat, the angle of a backrest of the driver's seat, the angle of a side mirror, and the like to positions or angles suitable for the user has been developed. As an example of a user authentication technology that can be applied to this technology, there is, for example, an authentication system disclosed in Japanese Unexamined Patent Application, First Publication No. 2002-229955 (hereinafter, Patent Literature 1).

The authentication system according to Patent Literature 1 includes an input unit for inputting biometric information of a user, a display unit for displaying the input biometric information, and an authentication unit for individually authenticating the user registered in advance based on the input biometric information, and the display unit includes an information terminal device characterized to display a frame for designating a size and a position of the input biometric information.

Incidentally, in general, user authentication does not always succeed the first time. For this reason, for example, Patent Literature 1 discloses a technology of performing authentication by extracting a face image again when authentication fails.

### SUMMARY OF THE INVENTION

However, since the authentication system described above requires a user to use an information terminal device such as a mobile phone equipped with a camera, this may annoy the user.

On the other hand, when the user authentication is executed using an imaging device mounted in a vehicle, the annoyance described above can be reduced. However, in this case, the user extends a hand to operate a reception image displayed on the imaging device along with guidance for an operation of user authentication or the like, and the hand blocks a space between the imaging device and a face of the user, and thereby user authentication may fail in some cases.

Aspects according to the present invention have been made in view of such circumstances, and one of objects thereof is to provide an authentication device capable of reducing a probability that user authentication fails.

The present invention has adopted the following aspects to solve the problems described above.

(1): An authentication device according to one aspect of the present invention includes a display unit configured to have a display surface and have a function of detecting that a user has contacted the display surface, an imaging unit that is provided around the display surface of the display unit, a display control unit configured to control the display unit such that the display unit displays a reception image that receives an instruction to start user authentication, and an authentication unit configured to execute the user authentication using an image captured by the imaging unit at a time at which a predetermined time has elapsed since a time at which it is detected by the display unit that an operation of contacting the reception image has been performed.

(2): In the aspect of (1) described above, the display control unit may control the display unit such that the display unit displays the reception image at a position biased to a side of the display surface on which the imaging unit is provided.

(3): In the aspect of (2) described above, the imaging unit may be provided at a position lower than the display surface, and the display control unit may control the display unit such that the display unit displays the reception image at a position biased to a bottom of the display surface.

(4): In the aspect of (2) described above, the imaging unit may be provided at a position higher than the display surface, and the display control unit may control the display unit such that the display unit displays the reception image at a position biased to a top of the display surface.

(5): In the aspect of any one of (2) to (4) described above, the imaging unit may be provided at a position at which a center thereof in a horizontal direction is shifted from a center of the display surface in the horizontal direction.

(6): An authentication device according to another aspect of the present invention includes a display unit configured to have a display surface, an imaging unit that is provided around the display surface of the display unit, a display control unit configured to control the display unit such that the display unit displays a target image, a determination unit configured to determine whether a line of sight of a user is directed to the target image on the basis of an image captured by the imaging unit, and an authentication unit configured to execute user authentication using an image captured by the imaging unit when the determination unit determines that a line of sight of a user is directed to the target image.

(7): In the aspect of (6) described above, the display control unit may control the display unit such that the display unit displays the target image at a position biased to a side of the display surface on which the imaging unit is provided.

(8): An authentication device according to still another aspect of the present invention includes a display unit, an imaging unit that is provided around a display surface of the display unit, a display control unit configured to control the display unit such that the display unit displays a target image, a notification unit configured to perform notification such that a user visually recognizes the target image, and an authentication unit configured to execute user authentication using an image captured by the imaging unit at a time at which a predetermined time has elapsed since a time at which the notification unit performed notification.

According to the aspects of (1) to (8) described above, it is possible to avoid a situation in which a hand or arm of a user is reflected in an image of the user and to reduce a probability that user authentication fails by capturing the image of the user when the user is not extending a hand to the display unit.

According to the aspect of (2) described above, it is possible to reduce the probability that user authentication fails by causing the reception image to be displayed at a position close to the imaging unit and making it easy for the imaging unit to capture an image suitable for user authentication.

According to the aspects of (3) to (5) described above, since user authentication is executed using the captured image of the user in a state in which the hand or arm of the user is not present between at least a part of the user whose image is captured by the imaging unit and the imaging unit, it is possible to reduce the probability that user authentication fails.

According to the aspect of (7) described above, it is possible to reduce the probability that user authentication fails by causing the target image to be displayed at a position close to the imaging unit and making it easy for the imaging unit to capture an image suitable for user authentication.

### BRIEF DESCRIPTION OF THE DRAWINGS

FIG. 1 is a diagram which shows an example of an authentication device according to a first embodiment.

FIG. 2 is a diagram which shows an example of the authentication device according to the first embodiment.

FIG. 3 is a diagram which shows an example of the authentication device according to the first embodiment.

FIG. 4 is a flowchart which shows an example of a flow of processing executed by the authentication device according to the first embodiment.

FIG. 5 is a diagram which shows an example of an authentication device according to a second embodiment.

FIG. 6 is a flowchart which shows an example of a flow of processing executed by the authentication device according to the second embodiment.

FIG. 7 is a diagram which shows an example of an authentication device according to a third embodiment.

FIG. 8 is a flowchart which shows an example of a flow of processing executed by the authentication device according to the third embodiment.

### DETAILED DESCRIPTION OF THE INVENTION

Hereinafter, embodiments of an authentication device according to the present invention will be described with reference to the drawings.

### First Embodiment

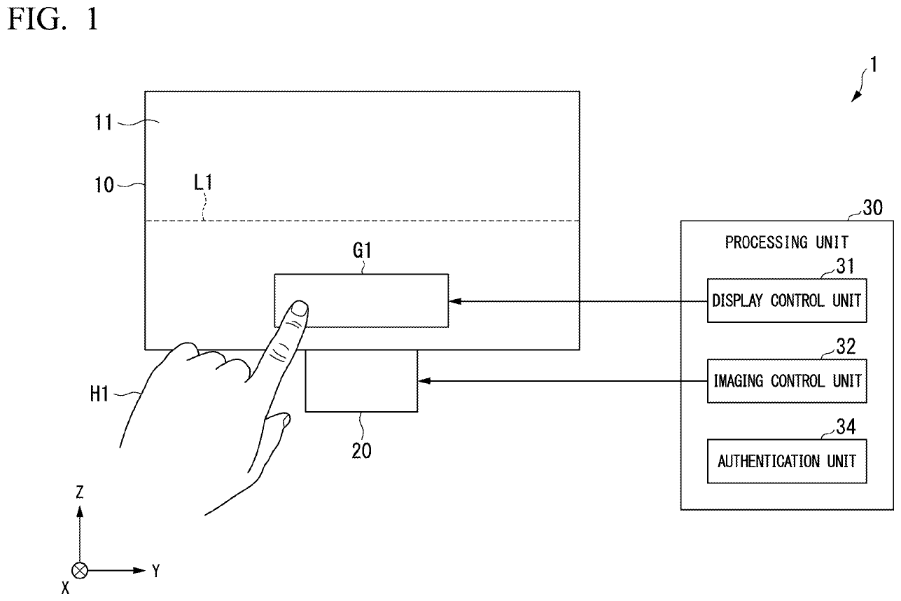

With reference to FIG. 1, an authentication device according to the first embodiment will be described. An authentication device 1 is, for example, mounted in a vehicle and performs user authentication on an occupant (user).

FIG. 1 is a diagram which shows an example of an authentication device according to the first embodiment. As shown in FIG. 1, the authentication device 1 includes a display unit 10, an imaging unit 20, and a processing unit 30. FIG. 1 shows the display unit 10 and a first positional relationship between an image and the imaging unit 20. In FIG. 1, an X axis is a traveling direction of a vehicle, and a Y axis is a width direction of the vehicle, and a Z axis is a vertical direction. The display unit 10 sets, for example, a plane that is parallel to a Y axis and has an inclination to a Z axis as a display surface 11. The display unit 10 and the imaging unit 20 are disposed at, for example, a center portion of an instrument panel of the vehicle in a vehicle width direction. In this case, if the vehicle is a right hand-drive vehicle, the display unit 10 and the imaging unit 20 are disposed obliquely to a left side of the driver's seat.

The display unit 10 is, for example, a touch panel display formed by integrating a display device such as a liquid crystal display (LCD) or an organic electroluminescence (EL) and a contact detection mechanism. The display unit 10 displays an image on the display surface 11 and detects a contact operation position on the display surface 11. An occupant (user) of a vehicle in which the authentication device 1 is mounted performs a contact operation on the display unit 10 using a hand H1.

The imaging unit 20 is, for example, provided in the vehicle compartment of the vehicle. The imaging unit 20 is, for example, a digital camera using a solid-state imaging element such as a charge coupled device (CCD) or a complementary metal oxide semiconductor (CMOS) and captures an image of a space in the vehicle compartment. A direction in which the imaging unit 20 captures an image is set to include, for example, a space above the driver's seat of the vehicle and is set such that the imaging unit 20 can capture an image of the head of a user sitting in the driver's seat obliquely from below.

In the first positional relationship shown in FIG. 1, the imaging unit 20 is provided around the display unit 10 and at a position lower than the display surface 11 of the display unit 10. A vicinity of the display unit 10 is, for example, an area that is within a range of a visual field when an occupant visually recognizes the display surface 11. The imaging unit 20 is disposed, for example, as shown in FIG. 1, to be in contact with or in close contact with an edge portion supporting the display surface 11 of the display unit 10. The imaging unit 20 may be supported by, for example, a member that supports the display surface of the display unit 10.

The processing unit 30 includes, for example, a display control unit 31, an imaging control unit 32, and an authentication unit 34. These components are realized, for example, by a hardware processor such as a central processing unit (CPU) executing a program (software). Some or all of these components may be realized by hardware (a circuit unit; including circuitry) such as a large scale integration (LSI), an application specific integrated circuit (ASIC), a field-programmable gate array (FPGA), and a graphics processing unit (GPU), or may also be realized by cooperation of software and hardware.

The display control unit 31 controls the display unit 10 such that it displays the reception image G1 that receives an instruction to start user authentication. The reception image G1 is a graphical user interface (GUI) displayed on the display surface 11, and is, for example, an image in a form of buttons, icons, check boxes, or the like.

The display control unit 31 controls, for example, the display unit 10 such that it displays the reception image G1 at a position biased to a side of the display surface 11 on which the imaging unit 20 is provided. The “position biased to” herein means that a center of the reception image G1 in the vertical direction is positioned below a center line L1 of the display surface 11 in the vertical direction.

The imaging control unit 32 controls the imaging unit 20 such that it captures an image within a predetermined time from a time at which a contact operation to the reception image G1 is detected. The predetermined time is, for example, a time from several tenths of a second to several seconds.

The imaging control unit 32 may extract an image captured within the predetermined time after the time at which a contact operation with respect to the reception image G1 is detected while the imaging unit 20 repeatedly captures an image.

The authentication unit 34 executes user authentication using an image captured by the imaging unit 20 at a time at which the predetermined time has elapsed since a time at which it is detected by the display unit 10 that an operation of contacting the reception image G1 has been performed.

For example, the authentication unit 34 recognizes the user by executing face authentication using a portion of the captured image that reflects the face of the user. Alternatively, the authentication unit 34 may recognize the user by executing iris authentication using a portion of the captured image that reflects the eyes of the user. A trained model learned according to machine learning may be used for the processing of the authentication unit 34. When user authentication is established, the authentication unit 34 outputs a message to devices that use a result of the authentication. The devices that use a result of the authentication are, for example, devices that enable a use of contents such as a mechanism that adjusts a position of the driver's seat, an angle of a backrest of the driver's seat, and an angle of a side mirror to positions registered in advance for each user, a car navigation device, music, a mail-order sale, and Internet shopping.

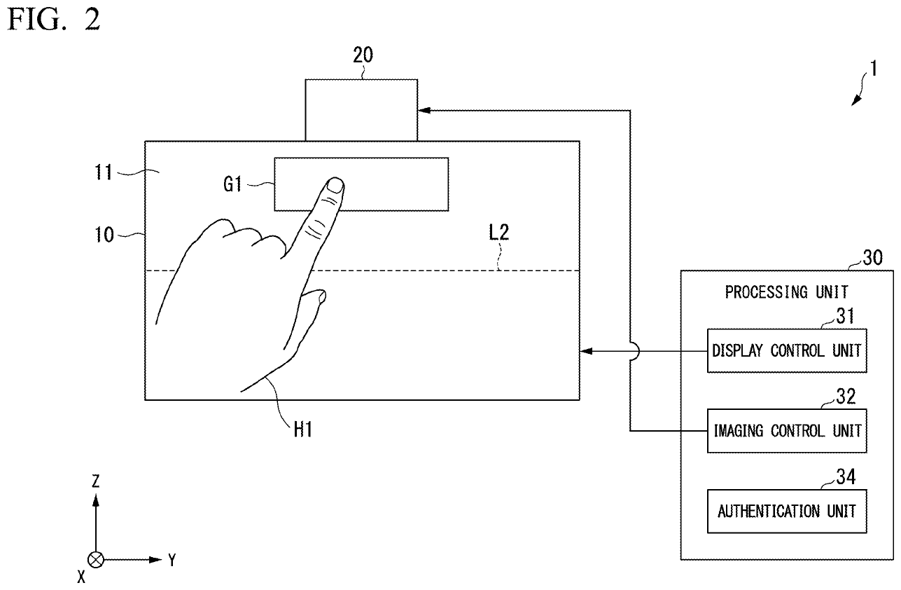

FIG. 2 is a diagram which shows an example of an authentication device in which the display unit 10, the image, and the imaging unit 20 are disposed in a second positional relationship. In the second positional relationship shown in FIG. 2, the imaging unit 20 is provided around the display unit 10 (similar to the description above) and at a position higher than the display surface 11 of the display unit 10. The display control unit 31 controls, for example, the display unit 10 such that it displays the reception image G1 at the position biased to the side of the display surface 11 on which the imaging unit 20 is provided. The “biased position” herein means that the center of the reception image G1 in the vertical direction is positioned above a center line L2 of the display surface 11 in the vertical direction.

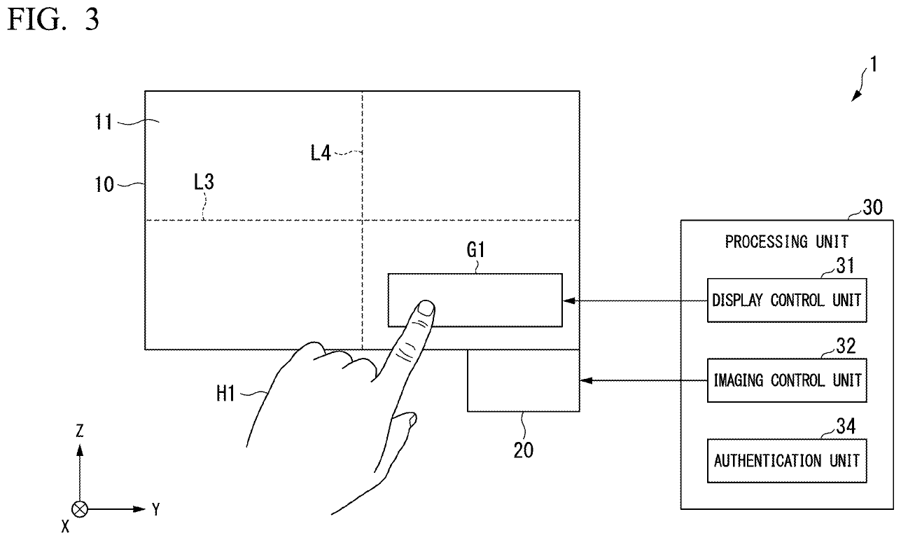

FIG. 3 is a diagram which shows an example of an authentication device in which the display unit 10, an image, and the imaging unit 20 are arranged in a third positional relationship. In the third positional relationship shown in FIG. 3, the imaging unit 20 is provided around the display unit 10 (similar to the description above), and at a position lower than the display unit 10 and biased to a right side. In this case, the display control unit 31 controls the display unit 10 such that it displays the reception image G1 at the position biased to the side of the display surface 11 on which the imaging unit 20 is provided. The “biased position” herein means that the center of the reception image G1 in the vertical direction is positioned below a center line L3 of the display surface 11 in the vertical direction and further on a right side than a center line L4 of the display surface 11 in the horizontal direction.

Although not shown in FIG. 3, the imaging unit 20 may be provided around the display unit 10 (similar to the description above), and at a position higher than the display unit 10 and biased to the right side, and the reception image G1 may also be similarly set to be biased to an upper right area.

Since the imaging unit 20 is disposed at a position close to the driver's seat by being provided at a position biased to a right side of the display unit 10, it is possible to capture an image with more information amount. If the vehicle is a left hand-drive vehicle, the imaging unit 20 may be provided at a position biased to a left side of the display unit 10.

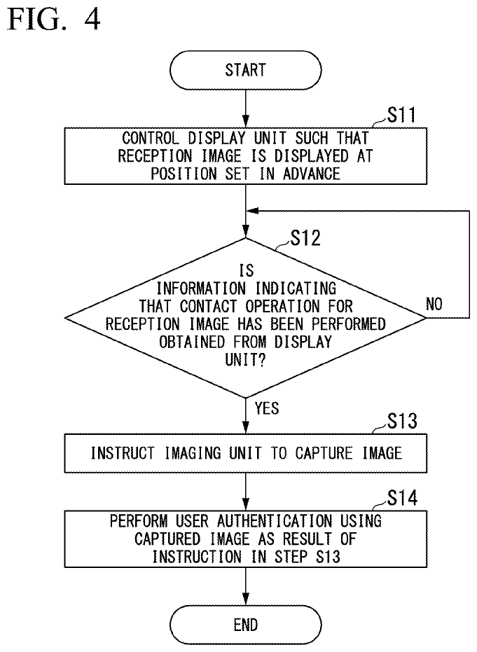

Next, processing executed by the authentication device 1 according to the first embodiment will be described with reference to FIG. 4. FIG. 4 is a flowchart which shows an example of a flow of the processing executed by the authentication device according to the first embodiment. Processing of this flowchart is started, for example, at a timing at which the vehicle system is turned on (accessory on, ignition on, or the like).

First, the display control unit 31 controls the display unit 10 such that it displays the reception image G1 at a position set in advance (step S11).

Next, the imaging control unit 32 determines whether information indicating that a contact operation for the reception image G1 has been performed is obtained from the display unit 10 (step S12). When the information is obtained from the display unit 10, the imaging control unit 32 waits until a predetermined time elapses and instructs the imaging unit 20 to capture an image (step S13).

Next, the authentication unit 34 performs user authentication using the image captured as a result of the instruction in step S13 (step S14). As a result, one routine processing of this flowchart ends.

According to the first embodiment described above, the imaging unit 20 is disposed around the display surface 11 of the display unit 10, and the display control unit 31 controls, for example, the display unit 10 such that it displays the reception image G1 at a position biased to a side of the display surface 11 on which the imaging unit 20 is provided. As a result, since the user touches the reception image G1 after visually recognizing the display unit 10 to perform a contact operation, a direction of the line of sight of the user at this time is toward a direction of the imaging unit 20 near the display surface 11, and thereby imaging is performed in a state suitable for face recognition and iris recognition. Since it is assumed that the user withdraws the hand H1 before a predetermined time elapses, it is possible to reduce a probability that the user authentication fails by performing user authentication using the image when the predetermined time has elapsed since the contact operation.

### Second Embodiment

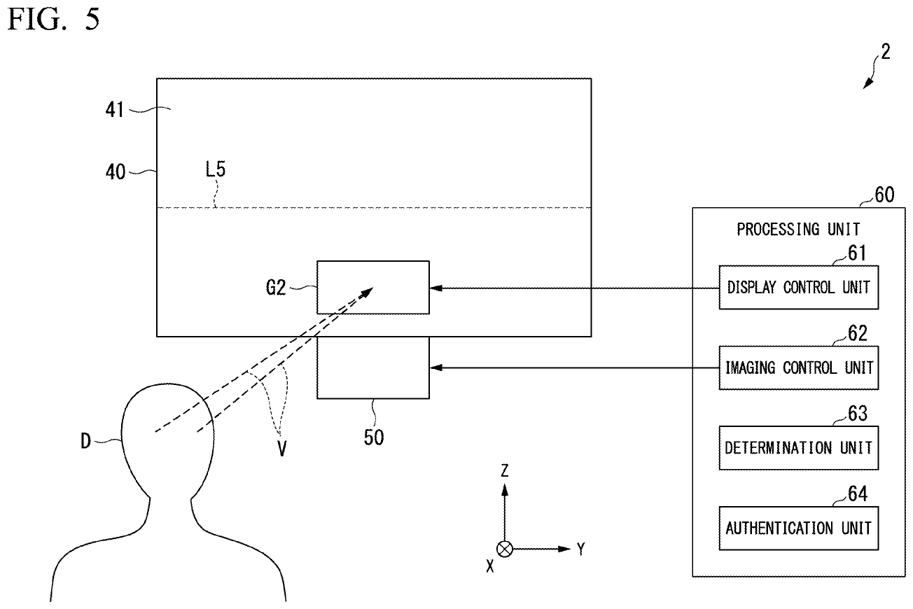

Hereinafter, a second embodiment will be described. FIG. 5 is a diagram which shows an example of an authentication device according to the second embodiment. As shown in FIG. 5, an authentication device 2 includes a display unit 40, an imaging unit 50, and a processing unit 60.

The display unit 40 is, for example, a display device such as an LCD or an organic EL. The display unit 40 causes an image to be displayed on a display surface 41.

The imaging unit 50 is, for example, provided in a vehicle compartment of a vehicle. The imaging unit 50 is, for example, a digital camera that uses a solid-state imaging element such as a CCD or a CMOS and captures an image of the space inside the vehicle compartment. A direction in which the imaging unit 20 captures an image is set to include, for example, a space above the driver's seat of the vehicle and is set such that the imaging unit 20 can capture an image of the head of a user sitting in the driver's seat obliquely from below.

In the positional relationship shown in FIG. 5, the imaging unit 50 is provided around the display unit 40 and at a position lower than the display surface 41 of the display unit 40. “Being around” is the same as in the first embodiment. The imaging unit 50 may be supported by, for example, a member that supports the display surface 41 of the display unit 40.

The processing unit 60 includes, for example, a display control unit 61, an imaging control unit 62, a determination unit 63, and an authentication unit 64. These components are realized, for example, by a hardware processor such as a CPU executing a program (software). Some or all of these components may be realized by hardware (circuit unit; including a circuitry) such as an LSI, an ASIC, an FPGA, a GPU, or the like, or may be realized by cooperation of software and hardware.

The display control unit 61 controls the display unit 40 such that it displays a target image G2 to attract attention when user authentication is started. The target image G2 is an image in any form.

The display control unit 61 controls the display unit 40 such that it displays the target image G2, for example, at a position biased to a side of the display surface 41 on which the imaging unit 50 is provided. The “position biased to” herein means that a center of the target image G2 in the vertical direction is positioned below a center line L5 of the display surface 41 in the vertical direction.

The imaging control unit 62 controls the imaging unit 50 such that it repeatedly captures an image with a timing at which the target image G2 is displayed as a starting time.

The determination unit 63 determines whether a line of sight V of the user D is directed to the target image G2 by using the image captured by the imaging unit 50. For example, the determination unit 63 executes processing of recognizing a direction of the face or a direction of a pupil of the user D depicted in the image and determines whether the line of sight V of the user D is directed to the target image G2 on the basis of a result of the processing.

The determination unit 63 may determine that the line of sight V of the user D is directed to the target image G2 when the line of sight V of the user D is directed to the target image G2 over a predetermined time on the basis of a plurality of images composing a moving image captured by the imaging unit 50 and may determine that the line of sight V of the user D is directed to the target image G2 when the line of sight V of the user D is directed to the target image G2 over a predetermined time on the basis of a plurality of images captured at predetermined time intervals.

When the determination unit 63 determines that the line of sight V of the user D is directed to the target image G2, the authentication unit 64 executes the user authentication using the image captured by the imaging unit 50.

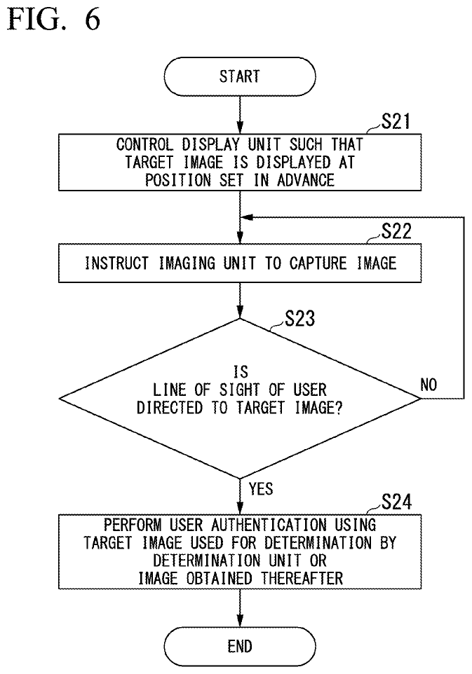

Next, processing executed by the authentication device 2 according to the second embodiment will be described with reference to FIG. 6. FIG. 6 is a flowchart which shows an example of the flow of processing executed by the authentication device according to the second embodiment. The processing of this flowchart is started, for example, at a timing at which the vehicle system is turned on (accessory on, ignition on, or the like).

First, the display control unit 61 controls the display unit 40 such that it displays the target image G2 at a position set in advance (step S21).

Next, the imaging control unit 62 instructs the imaging unit 50 to capture an image (step S22).

Next, the determination unit 63 determines whether the line of sight V of user D is directed to the target image G2 (step S23). When the determination unit 63 determines that the line of sight V of the user D is directed to the target image G2, the authentication unit 64 performs user authentication using the target image G2 used for the determination by the determination unit 63 or an image obtained thereafter (step S24). As a result, processing of one routine of this flowchart ends.

According to the second embodiment described above, the imaging unit 50 is disposed around the display surface 41 of the display unit 40, and the display control unit 61 controls, for example, the display unit 40 such that it displays the target image G2 at a position biased to a side of the display surface 41 on which the imaging unit 50 is provided. As a result, the line of sight of a user is directed to a direction closer to the imaging unit 50, and thus the authentication unit 64 can suitably perform face recognition and iris recognition.

### Third Embodiment

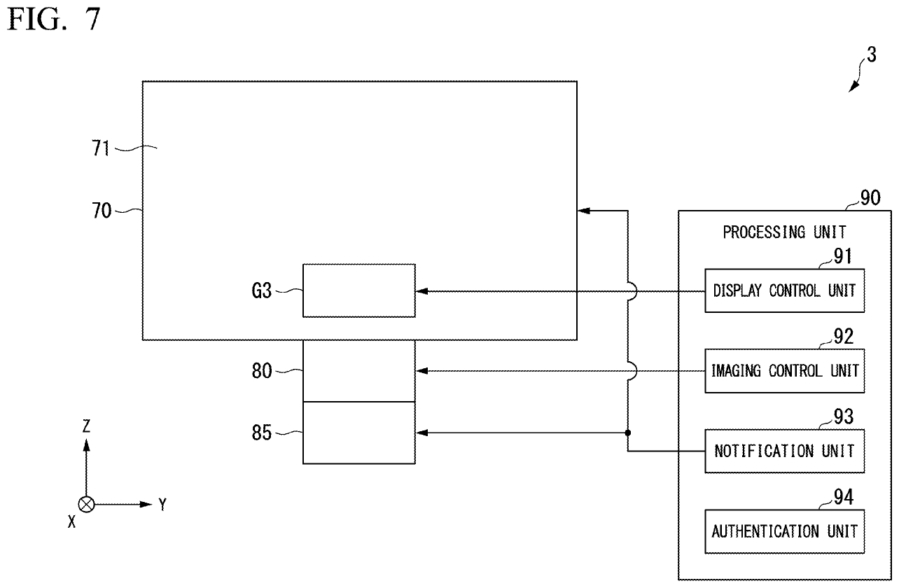

Hereinafter, a third embodiment will be described. FIG. 7 is a diagram which shows an example of an authentication device according to the third embodiment. As shown in FIG. 7, an authentication device 3 includes a display unit 70, an imaging unit 80, an acoustic unit 85, and a processing unit 90.

The display unit 70 is, for example, a display device such as an LCD or an organic EL. The display unit 70 causes an image to be displayed on a display surface 71.

The imaging unit 80 is, for example, provided in a vehicle compartment of a vehicle. The imaging unit 80 is, for example, a digital camera using a solid-state imaging element such as a CCD or a CMOS and captures an image of a space in the vehicle compartment. A direction in which the imaging unit 20 captures an image is set to include, for example, a space above the driver's seat of the vehicle and is set so that the imaging unit 20 can capture an image of the head of a user sitting in the driver's seat obliquely from below.

In a positional relationship shown in FIG. 7, the imaging unit 80 is provided around the display unit 70 and at a position lower than the display surface 71 of the display unit 70. “Being around” is the same as in the first embodiment. The imaging unit 80 may be supported by, for example, a member that supports the display surface 71 of the display unit 70.

The acoustic unit 85 is provided, for example, in the vehicle compartment of the vehicle. The acoustic unit 85 is, for example, a car audio speaker including a diaphragm, a frame, and a magnet, and emits sound toward the space in the vehicle compartment. In FIG. 7, it is expressed that the imaging unit 80 and the acoustic unit 85 are provided in close contact with each other, but there is no particular limit on an installation position of the acoustic unit 85.

The processing unit 90 includes, for example, a display control unit 91, an imaging control unit 92, a notification unit 93, and an authentication unit 94. These components are realized by, for example, a hardware processor such as a CPU executing a program (software). Some or all of these components may be expressed by hardware (circuit unit; including a circuitry) such as an LSI, an ASIC, an FPGA, a GPU, or the like, or may be realized by cooperation of software and hardware.

The display control unit 91 controls the display unit 70 such that it displays the target image G3 that asks the user to direct the line of sight when user authentication is started. The target image G3 is an image in any form.

The imaging control unit 92 determines whether a predetermined time has elapsed since the notification by the notification unit 93 was performed. Then, the imaging control unit 92 controls the imaging unit 80 such that it captures an image using user authentication at a time at which a predetermined time has elapsed since the notification by the notification unit 93 was performed. Here, the predetermined time is, for example, a time from several tenths of a second to several seconds.

The notification unit 93 notifies a user to visually recognize the target image G3. The notification unit 93 may cause a character or an image indicating that the user is required to visually recognize the target image G3 to be displayed on the display surface 71 and may also cause the acoustic unit 85 to output speech indicating that the user is required to visually recognize the target image G3.

The authentication unit 94 executes user authentication using an image captured by the imaging unit 80 at the time at which the predetermined time has elapsed since notification by the notification unit 93 was performed.

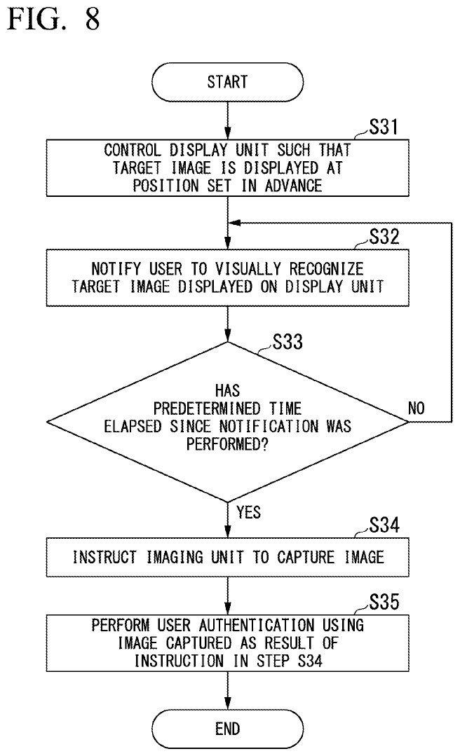

Next, processing executed by the authentication device 3 according to the third embodiment will be described with reference to FIG. 8. FIG. 8 is a flowchart which shows an example of a flow of processing executed by the authentication device according to the third embodiment. The processing of this flowchart is started, for example, at a timing at which the vehicle system is turned on (accessory on, ignition on, or the like)

First, the display control unit 91 controls the display unit 70 such that it displays the target image G3 at a position set in advance (step S31).

Next, the notification unit 93 notifies the user to visually recognize the target image G3 displayed on the display unit 70 (step S32).

Next, the imaging control unit 92 determines whether the predetermined time has elapsed since the notification was performed (step S33). When the imaging control unit 92 determines that the predetermined time has elapsed since the notification was performed, it instructs the imaging unit 80 to capture an image (step S34). When the authentication unit 94 executes user authentication using an image captured as a result of step S34 (step S35). As a result, processing of one routine of this flowchart ends.

According to the third embodiment described above, the display control unit 91 displays the target image G3 on the display surface 71 of the display unit 70, the notification unit 93 notifies the user to visually recognize the target image G3, and the authentication unit 94 performs user authentication at the time at which the predetermined time has elapsed since the notification was performed. As a result, a likelihood that the line of sight of the user is directed to a direction of the imaging unit 50 is improved, and thus the authentication unit 94 can suitably perform face recognition and iris recognition.

In the first embodiment described above, a case in which the processing of the flowchart shown in FIG. 4 is started at a timing at which the vehicle system is turned on has been described as an example, but the present invention is not limited thereto. For example, the processing of the flowchart shown in FIG. 4 may also be started at, for example, a timing at which a door of the vehicle is opened or closed, or a timing at which the driver has sat on the seat. In this case, only devices that enable the use of contents such as a car navigation device, music, a mail-order sale, Internet shopping are used, and the vehicle system does not have to be turned on, and this results in excellent convenience. These details are also applied to the second embodiment and the third embodiment.

As described above, forms for implementing the present invention have been described using the embodiments, but the present invention is not limited to the embodiment described above, and various modifications and substitutions can be made within a range not departing from the gist of the present invention.

What is claimed is:

1. An authentication device comprising:
a display unit configured to have a display surface and have a function of detecting that a user has contacted the display surface;
an imaging unit that is provided around the display surface of the display unit;
a display control unit configured to control the display unit such that the display unit displays a reception image that receives an instruction to start user authentication; and
an authentication unit configured to execute the user authentication using an image captured by the imaging unit at a time at which a predetermined time has elapsed since a time at which it is detected by the display unit that an operation of contacting the reception image has been performed.

2. The authentication device according to claim 1,
wherein the display control unit controls the display unit such that the display unit displays the reception image at a position biased to a side of the display surface on which the imaging unit is provided.

3. The authentication device according to claim 2,
wherein the imaging unit is provided at a position lower than the display surface, and
the display control unit controls the display unit such that the display unit displays the reception image at a position biased to a bottom of the display surface.

4. The authentication device according to claim 2,
wherein the imaging unit is provided at a position higher than the display surface, and
the display control unit controls the display unit such that the display unit displays the reception image at a position biased to a top of the display surface.

5. The authentication device according to claim 2,
wherein the imaging unit is provided at a position at which a center thereof in a horizontal direction is shifted from a center of the display surface in the horizontal direction.

6. An authentication device comprising:
a display unit configured to have a display surface;
an imaging unit that is provided around the display surface of the display unit;
a display control unit configured to control the display unit such that the display unit displays a target image;
a determination unit configured to determine whether a line of sight of a user is directed to the target image on the basis of an image captured by the imaging unit; and
an authentication unit configured to execute user authentication using an image captured by the imaging unit when the determination unit determines that a line of sight of a user is directed to the target image.

7. The authentication device according to claim 6,
wherein the display control unit controls the display unit such that the display unit displays the target image at a position biased to a side of the display surface on which the imaging unit is provided.

8. An authentication device comprising:
a display unit;
an imaging unit that is provided around a display surface of the display unit;
a display control unit configured to control the display unit such that the display unit displays a target image;
a notification unit configured to perform notification such that a user visually recognizes the target image; and
an authentication unit configured to execute user authentication using an image captured by the imaging unit at a time at which a predetermined time has elapsed since a time at which the notification unit performed notification.
